(19) United States
(12) Patent Application Publication
(10) Pub. No.: US 2010/0140568 A1
(43) Pub. Date: Jun. 10, 2010

(54) THERMOELECTRIC CONVERSION MATERIAL, METHOD FOR PRODUCING THE SAME, AND THERMOELECTRIC CONVERSION DEVICE

(75) Inventors: Tetsuro Tohma, Ehime (JP); Kazuo Sadaoka, Osaka (JP); Yoshio Uchida, Ibaraki (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: SUMITOMO CHEMICAL COMPANY, LIMITED, Chuo-ku, Tokyo (JP)

(21) Appl. No.: 12/594,831

(22) PCT Filed: Apr. 10, 2009
(86) PCT No.: PCT/JP2008/057457

§ 371 Date: Jan. 20, 2010

(30) Foreign Application Priority Data
Apr. 12, 2007 (JP) 2007-104643

(51) Int. Cl. H01B 1/08; B22F 3/10; B22F 1/00

(52) U.S. Cl. 252/519.12; 419/19; 75/232; 252/519.1

(57) ABSTRACT

A thermoelectric conversion material, a method for producing the same, and a thermoelectric conversion device are provided. The thermoelectric conversion material includes an oxide represented by formula (1): M¹O_{y} (1), where M¹ is at least one selected from the group consisting of V, Nb and Ta, and 1.90≦y≦2.10 or an oxide represented by formula (2): M¹₁₋ₓM²ₓO_{y} (2), where M¹ and y are as in formula (1), M² is selected from the group consisting of Ti, Cr, Mn, Fe, Co, Zr, Hf, Mo and W, and 0≦x≦0.5.

### TECHNICAL FIELD

The present invention relates to a thermoelectric conversion material, a method for producing the same, and a thermoelectric conversion device.

### BACKGROUND ART

Thermoelectric conversion electric power generation is power generation achieved by converting thermal energy into electric energy by a phenomenon in which a voltage (thermoelectromotive force) is generated when a temperature difference is established across a thermoelectric conversion material, that is, Seebeck effect. Since thermoelectric conversion electric power generation can use various kinds of waste heat, such as geothermal heat and heat of incinerators, as heat sources, this electric power generation is expected as environmentally friendly electric power generation that can be put into practical use.

The energy conversion efficiency of a thermoelectric conversion material depends on the figure of merit Z of the thermoelectric conversion material. The figure of merit Z is calculated from the following equation using the Seebeck coefficient α, the electric conductivity σ and the thermal conductivity κ of the material. As the FIGURE of merit Z of the thermoelectric conversion material is larger, the energy conversion efficiency thereof becomes higher. In particular, α²×σ in the equation is referred to as an output factor. As the output factor of the thermoelectric conversion material is larger, the output per unit temperature of a thermoelectric conversion device becomes higher.

Z=α²σ/κ

The thermoelectric conversion material is either a p-type thermoelectric conversion material having a positive Seebeck coefficient or an n-type thermoelectric conversion material having a negative Seebeck coefficient. Usually, a thermoelectric conversion device in which a p-type thermoelectric conversion material and an n-type thermoelectric conversion material are electrically connected in series is used for thermoelectric conversion electric power generation. The energy conversion efficiency of the thermoelectric conversion device depends on the figure of merit Z of the p-type thermoelectric conversion material and the figure of merit Z of the n-type thermoelectric conversion material. A p-type thermoelectric conversion material and an n-type thermoelectric conversion material, each having a large figure of merit Z, are required to obtain a thermoelectric conversion device having excellent energy conversion efficiency.

For example, JP-A-2005-276959 discloses an n-type thermoelectric conversion material obtained by mixing and reacting at least one kind of material serving as the source of an element selected from Ta, Nb and V with a material serving as the source of Ti.

### DISCLOSURE OF THE INVENTION

An object of the present invention is to provide a thermoelectric conversion material having a large output factor and a large figure of merit, a method for producing the thermoelectric conversion material, and a thermoelectric conversion device. The present inventors have studied and completed the present invention. More specifically, the present invention provides <1> to <10>.

<1> A thermoelectric conversion material comprising an oxide represented by formula (1):

M¹O_{y} (1)

where M¹ is at least one selected from the group consisting of V, Nb and Ta, and

1.90≦y≦2.10.

<2> A thermoelectric conversion material comprising an oxide represented by formula (2):

M¹₁₋ₓM²ₓO_{y} (2)

where M¹ is at least one selected from the group consisting of V, Nb and Ta, M² is at least one selected from the group consisting of Ti, Cr, Mn, Fe, Co, Zr, Hf, Mo and W,

0<x<0.5, and

1.90≦y≦2.10.

<3> The thermoelectric conversion material according to <1> or <2>, wherein the oxide has a rutile-type crystal structure.
<4> The thermoelectric conversion material according to <3>, wherein the lattice constant along the a-axis of the rutile-type crystal structure is not less than 0.4700 nm and not more than 0.4800 nm, and the lattice constant along the c-axis thereof is not less than 0.2980 nm and not more than 0.3200 nm.
<5> The thermoelectric conversion material according to any one of <1> to <4>, wherein M¹ is Nb.
<6> The thermoelectric conversion material according to any one of <1> to <5>, wherein the material is in form of a sintered body and the relative density of the sintered body is not less than 60%.
<7> The thermoelectric conversion material according to <6>, wherein the surface of the sintered body is coated with an oxygen impermeable film.
<8> A thermoelectric conversion device comprising the thermoelectric conversion material described according to any one of <1> to <7>.
<9> A method for producing the thermoelectric conversion material according to <1>, comprising the steps of a¹ and b¹:

a¹: preparing a raw material containing M¹ (at least one selected from the group consisting of V, Nb and Ta) and O, the molar amount of O being not less than 1.90 and not more than 2.10 times the molar amount of M¹,

b¹: sintering a green body obtained by forming the raw material at a temperature of not less than 900° C. and not more than 1700° C. under an inert gas atmosphere.

<10> A method for producing the thermoelectric conversion material according to <2>, comprising the steps of a² and b²:

a²: preparing a raw material containing M¹ (at least one selected from the group consisting of V, Nb and Ta), M² (at least one selected from the group consisting of Ti, Cr, Mn, Fe, Co, Zr, Hf, Mo and W) and O, the molar amount of M² being more than 0 and less than 0.5 times the total molar amount of M¹ and M², and the molar amount of O being not less than 1.90 and not more than 2.10 times the total molar amount of M¹ and M²,

b²: sintering a green body obtained by forming the raw material at a temperature of not less than 900° C. and not more than 1700° C. under an inert gas atmosphere.

### BRIEF DESCRIPTION OF THE DRAWINGS

FIG. 1 is an X-ray diffraction pattern of sintered body 1;

FIG. 2 is a graph showing the relationship between the lattice constants (along the a-axis and the c-axis) of the thermoelectric conversion materials of sintered bodies 1 to 4 and molar ratio x;

FIG. 3 is a graph showing changes in the Seebeck coefficients of sintered bodies 1 and 3 depending on temperature, T being absolute temperature (K);

FIG. 4 is a graph showing changes in the electric conductivities of sintered bodies 1 and 3 depending on temperature, T being absolute temperature (K);

FIG. 5 is a graph showing changes in the thermal conductivities of sintered bodies 1 and 3 depending on temperature, T being absolute temperature (K);

FIG. 6 is a graph showing changes in the output factors of sintered bodies 1 and 3 depending on temperature, T being absolute temperature (K); and

FIG. 7 is a graph showing changes in the non-dimensional figures of merit of sintered bodies 1 and 3 depending on temperature, T being absolute temperature (K).

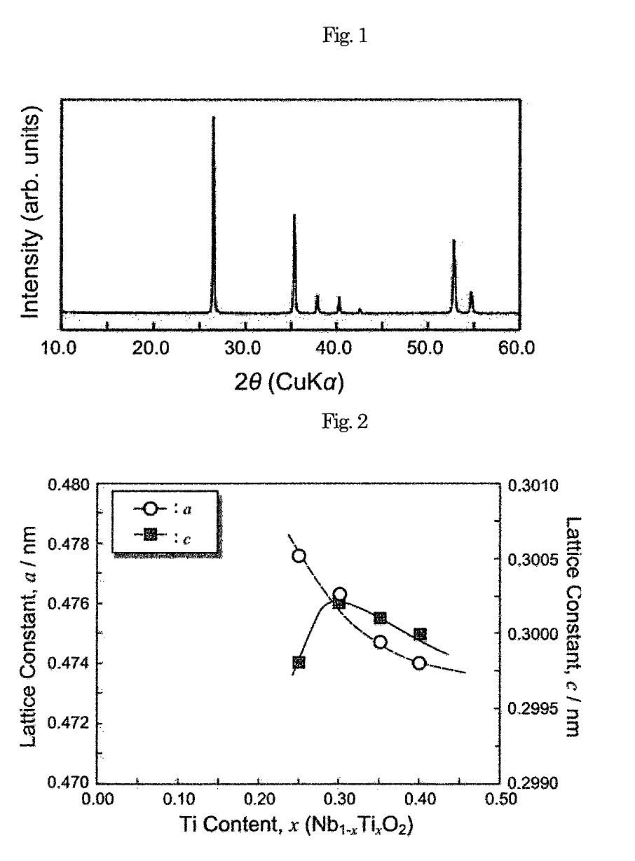

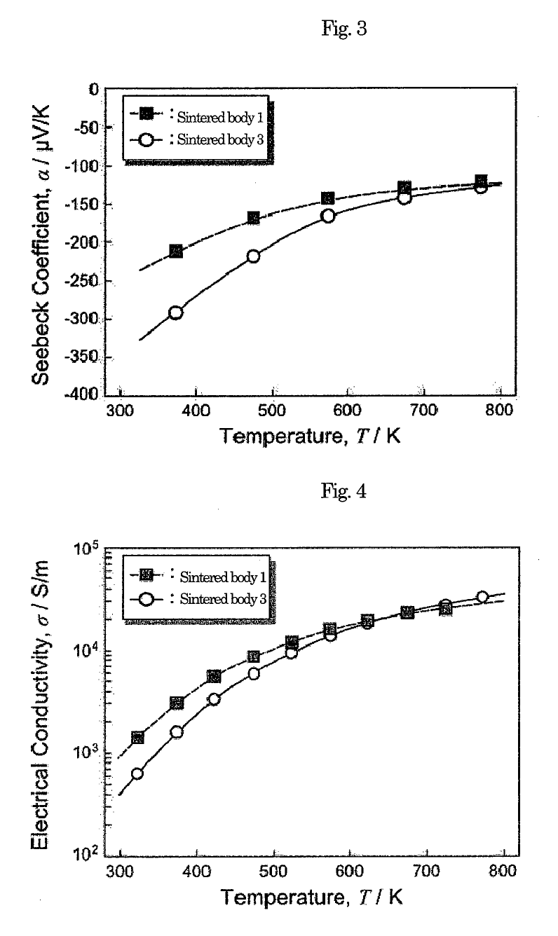

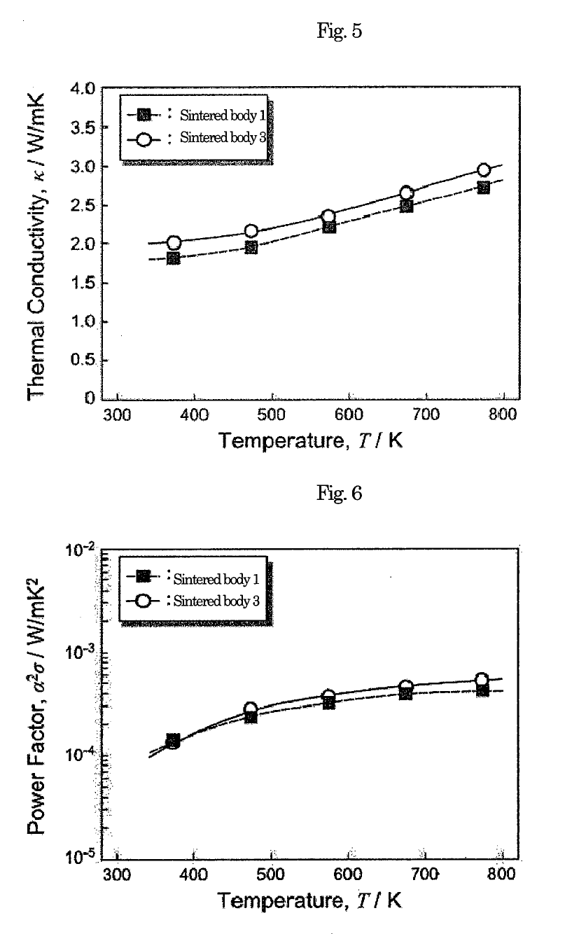

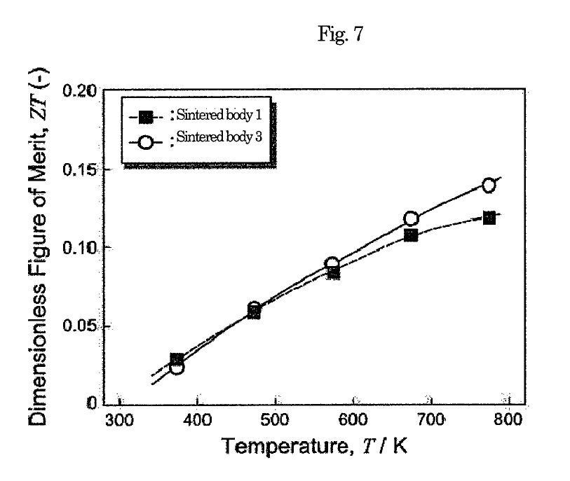

### MODE FOR CARRYING OUT THE INVENTION

### Thermoelectric Conversion Material

The thermoelectric conversion material according to the present invention comprises an oxide containing M¹ and oxygen (O).

M¹ is vanadium (V), niobium (Nb) or tantalum (Ta). Each of these may be used individually or in combination with another or more. To increase the output factor α²×σ, it is preferable that part or whole of M¹ is Nb, and it is further preferable that M¹ is Nb.

The oxide is represented by the above-mentioned formula (1).

In the formula (1), y is not less than 1.90, preferably not less than 1.95 and further preferably not less than 1.99, and not more than 2.10, preferably not more than 2.05 and further preferably not more than 2.02. When y is more than 2.10, impurity crystal phases (for example, Nb₂O₅, etc. M¹ is Nb) are produced, whereby the electric conductivity a tends to be smaller and the output factor α²×σ is not sufficient. On the other hand, when y is less than 1.90, impurity crystal phases (for example, NbO_{1.1}, etc. M¹ is Nb) are produced, whereby the Seebeck coefficient α tends to be smaller and the output factor α²×σ is not sufficient.

Furthermore, the oxide may further contain M². The oxide is represented by the above-mentioned formula (2).

M² is titanium (Ti), chromium (Cr), manganese (Mn), iron (Fe), cobalt (Co), zirconium (Zr), hafnium (Hf), molybdenum (Mo) or tungsten (W). Each of these may be used individually or in combination with another or more. To improve the output factor α²×σ, it is preferable that part or whole of M² is Ti, and it is further preferable that M² is Ti.

In the formula (2), x is more than 0, preferably not less than 0.20 and further preferably not less than 0.25, and less than 0.5. y is not less than 1.90, preferably not less than 1.95 and further preferably not less than 1.99, and not more than 2.10, preferably not more than 2.05 and further preferably not more than 2.02. When y is more than 2.10, impurity crystal phases (for example, TiNb₂O₇, Nb₂O₅, etc. M¹ is Nb and M² is Ti) are produced, whereby the electric conductivity a tends to be smaller and the output factor α²×σ is not sufficient. On the other hand, when y is less than 1.90, impurity crystal phases (for example, NbO_{1.1}, TiₙO₂ₙ₋₁, etc. M¹ is Nb and M² is Ti) are produced, the Seebeck coefficient α tends to be smaller, and the output factor α²×σ is not sufficient.

The oxide has the crystal structure of a rutile type, an anatase type or a brookite type. It is preferable that the oxide contains a rutile-type crystal structure, and it is further preferable that the oxide is in the form of a rutile-type crystal structure. When the oxide has the crystal structure of a rutile type, the oxide has an excellent energy conversion efficiency even though the oxide is used at high temperatures. It is thus possible to obtain a thermoelectric conversion device that is hardly degraded even after long-term use.

When the oxide has a rutile-type crystal structure, the rutile-type crystal structure has a lattice constant along the a-axis of not less than 0.4700 nm and not more than 0.4800 nm, and a lattice constant along the c-axis of not less than 0.2980 nm and not more than 0.3200 nm. For example, when M¹ is Nb, it is preferable that the rutile-type crystal structure has a lattice constant along the a-axis of not less than 0.4730 nm and not more than 0.4780 nm, and a lattice constant along the c-axis of not less than 0.2990 nm and not more than 0.3100 nm. The thermoelectric conversion material having the lattice constant along the a-axis and the lattice constant along the c-axis each falling within the above-mentioned ranges tends to have a larger output factor and a lower thermal conductivity. The lattice constants of the rutile-type crystal structure may be determined by identifying the peaks of the X-ray diffraction of the rutile-type crystal structure by using an X-ray diffraction pattern measured by X-ray diffraction at room temperature and by calculating the lattice constants from the values at the peak positions (2θ) using the least square method (for example, refer to “Crystal Analysis, Universal Program System (II)” edited by Toshio Sakurai, published by the Crystallographic Society of Japan, 1967).

A thermoelectric conversion material is usually in the form of powder, a sintered body, a thin film or a single crystal, preferably a sintered body. When a thermoelectric conversion material is in the form of a sintered body, the shape and size of the thermoelectric conversion material may be suitably adjusted for a thermoelectric conversion device. For example, the thermoelectric conversion material has the shape of a plate, a cylinder, a disc or a prism.

A thermoelectric conversion material in the form of a sintered body has a relative density of usually not less than 60%, preferably not less than 80%, further preferably not less than 85%, to ensure strength. The thermoelectric conversion material with a relative density of less than 60% tends to have a decreased electric conductivity σ.

### Method for Producing Thermoelectric Conversion Material

A thermoelectric conversion material may be produced by using a method of heating a raw material of the thermoelectric conversion material. A thermoelectric conversion material in the shape of a sintered body may be produced by using a method in which the raw material thereof are formed into a green body and the green body is sintered. The thermoelectric conversion material represented by the above-mentioned formula (1) may be produced, for example, by using the method comprising the steps of a¹ and b¹.

a¹: preparing a raw material containing M¹ (at least one selected from the group consisting of V, Nb and Ta) and oxygen (O), the molar amount of O being not less than 1.90 and not more than 2.10 times the molar amount of M¹,

b¹: sintering a green body obtained by forming the raw material at a temperature of not less than 900° C. and not more than 1700° C. under an inert gas atmosphere.

The thermoelectric conversion material represented by the above-mentioned formula (2) may be produced by using the method comprising the steps of a² and b².

a²: preparing a raw material containing M¹ (at least one selected from the group consisting of V, Nb and Ta), M² (at least one selected from the group consisting of Ti, Cr, Mn, Fe, Co, Zr, Hf, Mo and W) and O, the molar amount of M² being more than 0 and less than 0.5 times the total molar amount of M¹ and M², and the molar amount of O being not less than 1.90 and not more than 2.10 times the total molar amount of M¹ and M²,

b²: sintering a green body obtained by forming the raw material at a temperature of not less than 900° C. and not more than 1700° C. under an inert gas atmosphere.

### [Starting Material]

At step a¹ and step a², starting materials containing the metal element (M¹ or M²) is weighed and mixed to obtain a mixture so that the mixture has a predetermined composition, whereby a mixture is obtained in which the molar amount of O is not less than 1.90 and not more than 2.10 times the total molar amount of M¹ and M². Examples of the starting materials containing M¹ include an oxide, such as Nb₂O₅, Ta₂O₅ or V₂O₅, or a metal, such as Nb, Ta or V. Each of these may be used individually or in combination with another or more. Examples of the starting material containing M² include an oxide, such as TiO₂, Ti₂O₃, TiO, Cr₂O₃, MnO₂, Fe₂O₃, Fe₃O₄, FeO, CO₃O₄, CoO, ZrO₂, HfO₂, MoO₃ or WO₃, or a metal, such as Ti, Cr, Mn, Fe, Co, Zr, Hf, Mo or W. Each of these may be used individually or in combination with another or more. Furthermore, when pre-calcination or calcination described later is performed, instead of the above-mentioned oxides and metals, substances that can be decomposed and/or oxidized to oxides at high temperatures, such as hydroxides, carbonates, nitrates, halides or organic acid salts of the metal element (M¹ or M²) may also be used as the starting material containing the metal element (M¹ or M²).

### [Mixing]

Mixing may be performed using a dry method or a wet method. It is preferable that the mixing is performed by using a method in which a mixture uniformly containing metal elements is obtained. The mixing may be performed with a ball mill, a V-type mixer, a vibrating mill, an attritor, a dyno mill or a dynamic mill.

For producing a thermoelectric conversion material comprising an oxide represented by formula Nb_{0.60}Ti_{0.40}O_{2.00}, one of favorable compositions, Nb₂O₅, TiO₂ and Ti may be weighed and mixed to obtain a mixture so that the molar ratio of Nb, Ti and O is 0.60:0.40:2.00, and the mixture may be used as a raw material. In addition, for producing a thermoelectric conversion material comprising an oxide represented by formula Nb_{1.00}O_{2.00}, Nb₂O₅ and Nb may be weighed and mixed to obtain a mixture so that the molar ratio of Nb and O is 1.00:2.00, and the mixture may be used as a raw material.

### [Pre-Calcination]

When the mixture contains hydroxides, carbonates, nitrates, halides or organic acid salts, the mixture may be pre-calcined under an inert gas atmosphere or oxidized gas atmosphere before calcination to remove carbon dioxide, crystal water, etc. A pre-calcination temperature is usually not less than approximately 300° C. and not more than a calcination temperature described later, for example, not more than approximately 600° C.

### [Calcination]

When the mixture (or pre-calcined mixture) has a molar amount of O of more than 2.10 times the total molar amount of M¹ and M², the mixture may be calcined under a reducing gas atmosphere and used as a raw material. On the other hand, when the mixture (or pre-calcined mixture) has a molar amount of O of less than 1.90 times the total molar amount of M¹ and M², the mixture may be calcined under an oxidized gas atmosphere and used as a raw material. While the mixture (or pre-calcined mixture) has a molar amount of O of not less than 1.90 and not more than 2.10 times the total molar amount of M¹ and M², calcining the mixture under an inert gas atmosphere can reduce deformation during sintering in some cases. Calcination conditions depends on the composition, and a calcination temperature is usually not less than approximately 600° C. and not more than approximately 1100° C. and a calcination time is usually 0.5 to 24 hours. When the mixture contains hydroxides, carbonates, nitrates, halides or organic acid salts, it is possible to remove carbon dioxide gas, crystal water, etc. by calcination. The calcined mixture may be pulverized and used as a raw material. The pulverization may be performed with, for example, a ball mill, a vibrating mill, an attritor, a dyno mill or a dynamic mill. Furthermore, the mixture may be calcined after it is formed. Using the calcined mixture as a raw material can improve the uniformity of the composition of the sintered body and the uniformity of the structure thereof and reduce the deformation of the sintered body in some times.

### [Forming]

Forming may be performed with, for example, a uniaxial press, a cold isostatic press (CIP), a mechanical press, a hot press or a hot isostatic press (HIP). A binder, a dispersing agent and a releasing agent may be used for forming. A green body may have a shape suitable for a thermoelectric conversion device. Examples of the shape include a plate, a cylinder, a disc and a prism.

### [Sintering]

Sintering temperature is usually not less than 900° C., preferably not less than 1200° C., further preferably not less than 1250° C. and usually not more than 1700° C., preferably not more than 1600° C., further preferably not more than 1500° C. When the sintering temperature is less than 900° C., a solid phase reaction and sintering do not proceed in some cases, and the electric conductivity σ becomes lower depending on the composition in some cases. When the sintering temperature is more than 1700° C., the desired oxide is not obtained because the constituent elements melt and volatilize depending on the composition in some cases, and the thermoelectric conversion material has the reduced figure of merit Z in some cases. When calcination is performed before sintering, the sintering may be performed under an inert gas atmosphere at a temperature higher than the above-mentioned calcination temperature and not higher than 1700° C. The sintering time is usually approximately 0.5 to 24 hours. The inert gas atmosphere during the sintering is, for example, a nitrogen atmosphere or a rare gas atmosphere, preferably an atmosphere containing a rare gas, further preferably a rare gas atmosphere. Ar is used preferably as a rare gas from the viewpoint of operability. The forming and the sintering may be performed simultaneously. In this case, a hot press or a hot isostatic press (HIP) may be used.

Furthermore, the sintered body may be pulverized, re-sintered and used as a thermoelectric conversion material. The re-sintering may be performed under the same conditions as those of the above-mentioned sintering.

According to the above-mentioned production method, a thermoelectric conversion material in the form of a sintered body is obtained. The sintered body has a relative density of usually not less than 60%, preferably not less than 80%, further preferably not less than 85%. The relative density of the sintered body can be adjusted depending on the particle size of the material thereof before the sintering, forming pressure, sintering temperature, sintering time, etc.

Moreover, the sintered body may be coated with an oxygen impermeable film, through the surface of which oxygen hardly passes. The coating can reduce performance degradation to which surface oxidation leads in the thermoelectric conversion material. The oxygen impermeable film is formed of alumina, titania, zirconia, silica, silicon carbide, etc. The coating may be performed using, for example, an aerosol deposition, a spraying or a CVD (chemical vapor deposition).

The thermoelectric conversion material may be produced by a method comprising a coprecipitation step, a method comprising a hydrothermal step, a method comprising a dry-up step, a method comprising a sputtering step, a method comprising a step in which CVD is performed, a method comprising a sol-gel step, a method comprising an FZ (floating zone melting) step or a method comprising a TSCG (template single crystal growing method) in addition to the above-mentioned method.

### Thermoelectric Conversion Device

A thermoelectric conversion device comprises the above-mentioned thermoelectric conversion material.

Since the thermoelectric conversion material is usually an n-type, the thermoelectric conversion device comprises a p-type thermoelectric conversion material, an n-electrode and a p-electrode in addition to the above-mentioned n-type thermoelectric conversion material. As the p-type thermoelectric conversion material, for example, NaCO₂O₄ or Ca₃CO₄O₉ may be used (JP-A-9-321346 and JP-A-2001-64021). The thermoelectric conversion device may be produced so as to have the structure disclosed, for example, in JP-A-5-315657.

### EXAMPLES

The present invention will be illustrated in further detail with reference to Examples. The properties and structure of a thermoelectric conversion material are determined by using the methods described below.

### 1. Electric Conductivity σ (S/m)

A sintered body sample was formed to be in the shape of a prism, platinum wires were attached using silver paste, and the electric conductivity was measured using a direct current four-terminal method. The measurement was performed while the temperature was changed in the range of from room temperature to 500° C. under nitrogen gas stream.

### 2. Seebeck Coefficient α (μV/K)

R thermocouple wires and platinum wires were attached across both ends of a sample formed to be in the shape of a prism as in the measurement of electric conductivity, and the temperature and the thermoelectromotive force of the sample were measured. The measurements were performed while the temperature was changed in the range of from room temperature to 500° C. under nitrogen gas stream. One side of the sample was cooled using a cooling pipe to form a low-temperature portion. The temperatures at both ends of the sample were measured, and the thermoelectromotive force ΔV generated across both end faces of the sample was also measured. The temperature difference ΔT across both ends of the sample was adjusted in the range of from 0.5 to 10° C. by adjusting the temperature of the low-temperature portion, and the Seebeck coefficient α was calculated from the slopes of ΔT and ΔV.

### 3. Thermal Conductivity (W/mK)

The specific heat and the thermal diffusion factor of a sintered body sample were measured using the laser flash method in vacuum while the temperature was changed in the range of from room temperature to 500° C. A laser thermal constants measuring system TC-7000 manufactured by ULVAC-RIKO, Inc was used.

### 4. Structure and Composition Analysis

The crystal structures of a powder sample and a sintered body sample were analyzed with an X-ray diffractometer RINT2500TTR manufactured by RIGAKU Co., Ltd. using the powder X-ray diffraction in which CuKα is used as a radiation source. The lattice constants (along the a-axis and the c-axis) of the rutile-type crystal structure of the sample were determined by identifying the peaks of the X-ray diffraction of the rutile-type crystal structure by using an X-ray diffraction pattern measured by X-ray diffraction and by calculating the lattice constants from the values at the peak positions 2θ using the least square method. The composition of the metal elements in the sample were measured with an X-ray fluorescence spectrometer PW1480 manufactured by Philips Inc. Furthermore, with respect to the amount of oxygen contained in the sample, the increase in weight at the time when the sample was heat treated at a temperature of not less than 1000° C. and not more than 1200° C. for 48 hours in the atmosphere was wholly calculated as the increased amount of oxygen.

### 5. Relative Density (%)

The density of a sintered body sample was measured using the Archimedes' method. The relative density was calculated on the basis of the density and the lattice constant data determined using the powder X-ray diffraction.

### Example 1

Niobium oxide (Nb₂O₅ manufactured by KOJUNDO CHEMICAL LABORATORY CO., LTD.), titanium oxide (TiO₂ manufactured by ISHIHARA TECHNO CORPORATION, Trade name: PT-401M) and titanium metal (Ti manufactured by KOJUNDO CHEMICAL LABORATORY CO., LTD.) were used as starting materials. The niobium oxide, titanium oxide and titanium metal were weighed (Table 1) and mixed with a dry ball mill (media: plastic balls) for 6 hours to obtain a mixture of Nb, Ti and O in the ratio of Nb:Ti:O=0.60:0.40:2.00 (in the molar ratio of Nb₂O₅:TiO₂:Ti=0.300:0.250:0.150). The mixture was formed into the shape of a disc using a uniaxial press (forming pressure: 200 kg/cm²) and calcined at 1000° C. for 3 hours under an argon atmosphere (purity: 99.9995%) to obtain a calcined mixture. The calcined mixture was pulverized using a dry method with a ball mill (media: zirconia balls) to obtain a pulverized mixture (raw material). The raw material was formed into the shape of a disc with a uniaxial press (forming pressure: 200 kg/cm²) to obtain a green body. The green body was sintered at 1300° C. for 6 hours under an argon atmosphere (purity: 99.9995%) with a sintering furnace to obtain sintered body 1.

The composition, lattice constants and relative density of sintered body 1 were shown in Table 2. The sintered body 1 had the crystal structure of a rutile type, a lattice constants along the a-axis of 0.4740 nm, and a lattice constants along the c-axis of 0.2998 nm. The sintered body 1 had the color of black and a relative density of 95.5%.

The Seebeck coefficient α, the electric conductivity σ, the thermal conductivity K, the output factor α²×σ and the non-dimensional figure of merit ZT of sintered body 1 at 500° C. were shown in Table 3. The non-dimensional figure of merit is calculated by multiplying the figure of merit Z (K⁻¹) by absolute temperature T(K).

### Examples 2 to 4

### Production of Sintered Bodies 2 to 4

Except that the amounts of the starting materials were changed as shown in Table 1, the same procedures as in Example 1 was performed to obtain sintered bodies 2 to 4. The properties of sintered bodies 2 to 4 were shown in Tables 2 and 3. All of sintered bodies 2 to 4 had the crystal structures of a rutile type.

### Example 5

### Production of Sintered Body 5

Except that the amounts of the starting materials were changed as shown in Table 1, the same procedures as in Example 1 was performed to obtain sintered body 5. The properties of sintered body 5 were shown in Tables 2 and 3. Sintered body 5 had the crystal structure of nearly a rutile type.

TABLE 1

| | Materials and their | | | Nb₁₋ₓTiₓO_{y} at the | |
|---|---|---|---|---|---|
| | amounts (molar ratio) | | | time of weighing | |
| Sintered body | Nb₂O₅ | TiO₂ | Ti | x | y |
| Sintered body 1 | 0.3000 | 0.2500 | 0.1500 | 0.40 | 2.00 |
| Sintered body 2 | 0.3250 | 0.1875 | 0.1625 | 0.35 | 2.00 |
| Sintered body 3 | 0.3500 | 0.1250 | 0.1750 | 0.30 | 2.00 |
| Sintered body 4 | 0.3750 | 0.0625 | 0.1875 | 0.25 | 2.00 |
| Sintered body 5 | 0.6000 | 0.2000 | 0.2000 | 0.40 | 1.90 |

TABLE 2

| | Result of | | | | |
|---|---|---|---|---|---|
| | composition | | | | |
| | analysis | | Lattice | | |
| | Nb₁₋ₓTiₓO_{y} | | constants (nm) | | Relative |
| Sintered body | x | y | a-axis | c-axis | density % |
| Sintered body 1 | 0.40 | 1.99 | 0.4740 | 0.2998 | 95.5 |
| Sintered body 2 | 0.35 | 2.00 | 0.4747 | 0.3002 | 91.7 |
| Sintered body 3 | 0.30 | 2.01 | 0.4763 | 0.3001 | 97.8 |
| Sintered body 4 | 0.25 | 2.02 | 0.4776 | 0.3000 | 96.8 |
| Sintered body 5 | 0.40 | 1.93 | 0.4737 | 0.2999 | 79.6 |

TABLE 3

| | Seebeck | Electric | Thermal | | Non- |
|---|---|---|---|---|---|
| | coeffi- | conduc- | conduc- | Output | dimensional |
| | cient | tivity | tivity | factor | figure of merit |
| Sintered | α | σ | κ | α²σ | ZT |
| body | (μV/K) | (S/m) | (W/mK) | (W/mK²) | (—) |
| Sintered | −122 | 2.77 × 10⁴ | 2.71 | 4.15 × 10⁻⁴ | 0.118 |
| body 1 | | | | | |
| Sintered | −120 | 3.02 × 10⁴ | 2.68 | 4.34 × 10⁻⁴ | 0.125 |
| body 2 | | | | | |
| Sintered | −128 | 3.24 × 10⁴ | 2.94 | 5.29 × 10⁻⁴ | 0.139 |
| body 3 | | | | | |
| Sintered | −115 | 2.92 × 10⁴ | 2.79 | 3.83 × 10⁻⁴ | 0.106 |
| body 4 | | | | | |
| Sintered | −114 | 2.25 × 10⁴ | 2.10 | 2.90 × 10⁻⁴ | 0.107 |
| body 5 | | | | | |

### Comparative Examples 1 to 3

### Production of Sintered Bodies 6 to 8

Except that the amounts of the starting materials were changed as shown in Table 4, the same procedures as in Example 1 was performed to obtain sintered bodies 6-8. The properties of sintered bodies 6 to 8 were shown in Tables 5 and 6. All of sintered bodies 6 to 8 had two phases having different crystal structures, Nb₁₋ₓTiₓO₂ and TiNb₂O₇, each of which had a rutile-type crystal structure, and had lower density.

TABLE 4

| | Materials and their | | | Nb₁₋ₓTiₓO_{y} at the | |
|---|---|---|---|---|---|
| | amounts (molar ratio) | | | time of weighing | |
| Sintered body | Nb₂O₅ | TiO₂ | Ti | x | y |
| Sintered body 6 | 0.0500 | 0.9000 | 0.0000 | 0.90 | 2.05 |
| Sintered body 7 | 0.0750 | 0.8500 | 0.0000 | 0.85 | 2.08 |
| Sintered body 8 | 0.1000 | 0.8000 | 0.0000 | 0.80 | 2.10 |

TABLE 5

Result of composition
analysis Nb₁₋ₓTiₓO_{y}

| Sintered body | x | y |
|---|---|---|
| Sintered body 6 | 0.90 | 2.03 |
| Sintered body 7 | 0.85 | 2.06 |
| Sintered body 8 | 0.80 | 2.08 |

TABLE 6

| | Seebeck | Electric | Thermal | | Non- |
|---|---|---|---|---|---|
| | coeffi- | conduc- | conduc- | Output | dimensional |
| | cient | tivity | tivity | factor | figure of merit |
| Sintered | α | σ | κ | α²σ | ZT |
| body | (μV/K) | (S/m) | (W/mK) | (W/mK²) | (—) |
| Sintered | −288 | 1.11 × 10³ | 1.52 | 9.21 × 10⁻⁵ | 0.047 |
| body 6 | | | | | |
| Sintered | −500 | 3.78 × l0² | 1.97 | 9.44 × 10⁻⁵ | 0.037 |
| body 7 | | | | | |
| Sintered | −349 | 1.82 × 10² | 2.18 | 2.22 × 10⁻⁵ | 0.008 |
| body 8 | | | | | |

### INDUSTRIAL APPLICABILITY

According to the present invention, a thermoelectric conversion material having a large output factor α²×σ and a large figure of merit Z is obtained.

1. A thermoelectric conversion material comprising an oxide represented by formula (1):
M¹O_{y} (1)
where M¹ is at least one selected from the group consisting of V, Nb and Ta, and 1.90≦y≦2.10.

2. A thermoelectric conversion material comprising an oxide represented by formula (2):
M¹₁₋ₓM²ₓO_{y} (2)
where M¹ is at least one selected from the group consisting of V, Nb and Ta, M² is at least one selected from the group consisting of Ti, Cr, Mn, Fe, Co, Zr, Hf, Mo and W,
0≦x≦0.5, and 1.90≦y≦2.10.

3. The thermoelectric conversion material according to claim 1, wherein the oxide has a rutile-type crystal structure.

4. The thermoelectric conversion material according to claim 3, wherein the lattice constant along the a-axis of the rutile-type crystal structure is not less than 0.4700 nm and not more than 0.4800 nm, and the lattice constant along the c-axis thereof is not less than 0.2980 nm and not more than 0.3200 nm.

5. The thermoelectric conversion material according to claim 1, wherein M¹ is Nb.

6. The thermoelectric conversion material according to claim 1, wherein the material is in the form of a sintered body and the relative density of the sintered body is not less than 60%.

7. The thermoelectric conversion material according to claim 6, wherein the surface of the sintered body is coated with an oxygen impermeable film.

8. A thermoelectric conversion device having said thermoelectric conversion material according to claim 1.

9. A method for producing said thermoelectric conversion material according to claim 1, comprising the steps of a¹ and b¹,
a¹: preparing a raw material containing M¹ (at least one selected from the group consisting of V, Nb and Ta) and O, the molar amount of O being not less than 1.90 and not more than 2.10 times the molar amount of M¹,
b¹: sintering a green body obtained by forming the raw material at a temperature of not less than 900° C. and not more than 1700° C. under an inert gas atmosphere.

10. A method for producing said thermoelectric conversion material according to claim 2, comprising the steps of a² and b²,
a²: preparing a raw material containing M¹ (at least one selected from the group consisting of V, Nb and Ta), M² (at least one selected from the group consisting of Ti, Cr, Mn, Fe, Co, Zr, Hf, Mo and W) and O, the molar amount of M² being more than 0 and less than 0.5 times the total molar amount of M¹ and M², and the molar amount of O being not less than 1.90 and not more than 2.10 times the total molar amount of M¹ and M²,
b²: sintering a green body obtained by forming the raw material at a temperature of not less than 900° C. and not more than 1700° C. under an inert gas atmosphere.

11. The thermoelectric conversion material according to claim 2, wherein the oxide has a rutile-type crystal structure.

12. The thermoelectric conversion material according to claim 11 wherein the lattice constant along the a-axis of the rutile-type crystal structure is not less than 0.4700 nm and not more than 0.4800 nm, and the lattice constant along the c-axis thereof is not less than 0.2980 nm and not more than 0.3200 nm.

13. The thermoelectric conversion material according to claim 2, wherein the material is in the form of a sintered body and the relative density of the sintered body is not less than 60%.

14. The thermoelectric conversion material according to claim 13, wherein the surface of the sintered body is coated with an oxygen impermeable film.

15. A thermoelectric conversion device having said thermoelectric conversion material according to claim 2.

16. The thermoelectric conversion material according to claim 2, wherein M¹ is Nb.
